(19) United States
(12) Patent Application Publication
(10) Pub. No.: US 2021/0061132 A1
(43) Pub. Date: Mar. 4, 2021

(54) Control Unit and Method for Conditioning an Energy Store of a Vehicle

(71) Applicant: Bayerische Motoren Werke Aktiengesellschaft, Muenchen (DE)

(72) Inventor: Clemens STEFANZIOSA, Muenchen (DE)

(21) Appl. No.: 16/958,059

(22) PCT Filed: Jan. 29, 2019
(86) PCT No.: PCT/EP2019/052081

§ 371 Date: Jun. 25, 2020

(30) Foreign Application Priority Data
Jan. 31, 2018 (DE) 10 2018 201 472.8

(51) Int. Cl. B60L 58/26; B60L 15/20; B60L 58/12; B60L 53/66; H02J 7/00

(52) U.S. Cl. CPC B60L 58/26; B60L 15/20; B60L 58/12; B60L 53/66; H02J 7/0047; B60L 2250/10; B60L 2240/545; B60L 2240/12; B60L 2240/42; B60L 2240/60; B60L 2250/00; H02J 7/00032

(57) ABSTRACT

A control unit for a vehicle includes an electric energy store for storing electric energy for an electric drive machine. The control unit is designed to determine that the vehicle is driving to a charging station in order to charge the energy store. In response to the determination, the control unit is additionally designed to initiate one or more usage-neutral or usage-reducing measures while the vehicle is traveling in order to reduce the temperature of the energy store in preparation for the charging process of the energy store.

### BACKGROUND AND SUMMARY OF THE INVENTION

The disclosed subject matter relates to a vehicle which is at least partially electrically driven. In particular, the disclosed subject matter relates to a control unit and to a corresponding method for conditioning the electrical energy store of an at least partially electrically driven vehicle in preparation for a charging process.

An at least partially electrically driven vehicle has an electric drive machine, which is supplied with electrical energy from an electrical energy store (for example a lithium-ion-based energy store). The energy store typically has a rated voltage of 300 V or more.

An energy store preferably has a storage capacity that is as large as possible, in order to make it possible for a vehicle to have the greatest possible range. On the other hand, the charging time for charging an energy store increases with increasing storage capacity. The charging times can be reduced by using rapid charging methods (for example, with particularly high charging currents). However, the use of a rapid charging method typically leads to the development of a relatively great amount of heat at the energy store, and consequently, to a relatively great cooling demand of the energy store. The cooling of an energy store usually involves relatively high energy consumption, which reduces the energy efficiency of a charging process and consequently the energy efficiency of a vehicle.

The present subject matter is concerned with the technical object of making a (rapid) charging process of a vehicle possible in an energy-efficient way.

The object is achieved by the independent claims. Advantageous embodiments are described inter alia in the dependent claims. It is pointed out that additional features of a patent claim dependent on an independent patent claim can form an invention without the features of the independent patent claim, or just in combination with some of the features of the independent patent claim, which stands on its own and is independent of the combination of all features of the independent patent claim and which can be made the subject of an independent claim, a divisional application or a subsequent application. This applies in the same way to technical teachings described in the description, which can form an invention that is independent of the features of the independent patent claims.

According to one aspect, a control unit for a vehicle is described. The vehicle is driven at least partially electrically. In particular, the vehicle comprises an electrical energy store for storing electrical energy for an electric drive machine of the vehicle. The energy store typically has a rated voltage of 300 V or more.

The control unit is designed to determine that the vehicle is driving to a charging station for charging the energy store. In other words, it can be determined that a charging process for charging the energy store is to be carried out directly following the (current) journey of the vehicle. In order to predict this, the control unit may be designed to ascertain navigation data with respect to a planned travel route of the vehicle. The navigation data may indicate a charging station for charging the energy store for example as a destination or as a stage along the travel route. Alternatively or in addition, the control unit may be designed to ascertain input data with respect to an input by a user via a user interface of the vehicle. For example, a user (in particular a driver) of the vehicle may be enabled to indicate explicitly via a user interface that a charging process is to be carried out directly following the current journey of the vehicle. It may be determined on the basis of the navigation data and/or on the basis of the input data that the vehicle is driving to a charging station for charging the energy store and/or that a charging process is to be carried out directly following the current journey.

The control unit is also designed to respond to this (i.e. to respond to the determination that the vehicle is on its way to a charging station) by initiating one or more consumption-neutral or consumption-reducing measures during the journey of the vehicle in order to reduce the temperature of the energy store in preparation for the charging of the energy store. In this case, the one or more measures may in particular be aimed to reduce the (initial) temperature of the energy store at the beginning of the charging of the energy store, in particular in comparison with a temperature that would occur if the one or more measures were not carried out.

The control unit is consequently designed to prepare the electrical energy store of a vehicle still during the journey of the vehicle in an energy-efficient way for a charging process directly following the journey. In particular, the effect that the energy store has a relatively low initial temperature at the beginning of the charging process can be achieved. This makes rapid charging possible, i.e. the use of a relatively high charging power, and consequently a shortening of the charging time of the charging process. For example, DC charging, for instance at 50 kW, 150 kW or more, can be made possible.

In this case, one or more consumption-neutral or consumption-reducing measures are initiated by the control unit. In other words, one or more measures by which the temperature of the energy store can be reduced, but the electrical energy consumption of the vehicle is at least not increased as a result, are initiated. As a consequence of this, the electrical energy store has a relatively great state of charge at the beginning of the charging process. In particular, the state of charge may possibly be greater than in the event that the one or more measures are not carried out. By increasing the state of charge of the energy store at the beginning of the charging process, a further reduction of the charging time can be made possible.

The control unit consequently makes it possible in an energy-efficient way to carry out a rapid charging process, and consequently, to reduce the charging time of the energy store of an at least partially electrically driven vehicle.

The one or more measures may comprise activating an energy-saving mode of an electrical consumer of the vehicle or deactivating an electrical consumer. The electrical consumer may in this case preferably be used for providing a comfort function, for example for air-conditioning the passenger compartment of the vehicle and/or for controlling the temperature of a vehicle seat. This allows the electrical energy consumption of the vehicle, and consequently the loading of the electrical energy store, to be reduced. This leads in turn to a reduction, or not so great an increase, in the temperature of the energy store. In particular, the effect that the initial temperature of the energy store at the beginning of the charging process is reduced (in comparison with the case where the one or more measures are not carried out) can be reliably achieved.

The one or more measures may comprise reducing the vehicle speed of the vehicle that is brought about by the electric drive machine. Typically, the electrical energy consumption, and consequently, the loading of the electrical energy store increase with increasing vehicle speed. In this case, the electric drive power typically represents a large part of the electrical energy provided by the electrical energy store. By adapting the vehicle speed, the temperature of the energy store can consequently be adapted, in particular reduced, in a particularly effective way.

The control unit may be designed to ascertain time information with respect to the reduction of the required charging time for charging the energy store on account of reducing the vehicle speed. In particular, it can be ascertained or predicted how much the initial temperature of the energy store at the beginning of the charging operation can be reduced by reducing the vehicle speed. The reduced initial temperature makes increased charging power possible, and consequently has the effect of shortening the charging time. Furthermore, the state of charge of the energy store at the beginning of the charging process that is obtained by reducing the vehicle speed can be ascertained or predicted. A relatively increased state of charge likewise allows the required charging time to be reduced. It can consequently be ascertained how much the charging time can be reduced by reducing the vehicle speed. On the other hand, the increase in the travel time as a result of the reduced vehicle speed can be ascertained.

The control unit may then be designed to ascertain the vehicle speed to be used in dependence on the time information. In this case, the traveling speed may be ascertained in such a way that the overall expenditure of time for the journey to the charging station and for the charging of the energy store is reduced, in particular minimized. Thus, a particularly reliable and great reduction in the charging time of an energy store is made possible.

In the case of a vehicle driving in at least partially automated manner, the reduction in the vehicle speed can be brought about automatically. Alternatively or in addition, the driver of the vehicle may, by issuing information with respect to the vehicle speed to be used, cause the vehicle to drive to the charging station according to the traveling speed ascertained.

The control unit may be designed to determine the charging power with which the energy store is to be charged. The one or more measures may possibly only be initiated whenever the charging power is equal to or greater than a power threshold value (for example of 50 kW or more). For example, preparation or conditioning of the energy store for the charging process, i.e. carrying out the one or more measures, may only be initiated when it is determined that a rapid charging process (with a relatively high charging power) is to be carried out directly following the journey. On the other hand, preparation or conditioning of the energy store may possibly be dispensed with (since such preparation is typically not required in the case of a charging process with a relatively low charging power). Consequently, the comfort for a user of the vehicle can be further increased.

The control unit may be designed to bring about an optical and/or acoustic and/or haptic output to a user of the vehicle, in order to indicate that the one or more measures for reducing the temperature of the energy store should be or are to be carried out. The one or more measures may then be initiated in dependence on an input by the user. In particular, the carrying out of the one or more measures for the preparation or conditioning of the energy store may be proposed to a user of the vehicle. The user may then select whether one or more measures are to be carried out, and if so which. Thus, the comfort for a user of the vehicle can be further increased.

The one or more measures may be increasing an air stream for cooling the electrical energy store. In this case, the air stream may be brought about by the relative wind of the traveling vehicle. The air stream may for example be increased in a consumption-neutral way, in that one or more fins and/or one or more air ducts, for example at the front of the vehicle, are opened, in order to achieve the effect that the energy store is flowed around by an increased volume flow of air. Thus, a reduction in the temperature of the energy store can be brought about (possibly accompanied by an increase in flow noises).

The control unit may also be designed to inform the charging station in advance via a wireless communication link that the vehicle is driving to the charging station to charge the energy store. Furthermore, the charging station for charging the energy store may be reserved. For this purpose, the expected time of arrival at the charging station may be predicted, in order to reserve a suitable time period for charging the energy store. The control unit may consequently be designed to pre-announce the (rapid) charging process at the charging station preferably to be driven to for charging the energy store. Optionally, this charging station may be reserved for the calculated charging time as from the expected arrival of the vehicle. It can in this way be ensured that the preconditioning of the energy store can also actually be used for carrying out a speeded-up charging process. Consequently, the comfort for a user can be further increased.

According to a further aspect, a method for operating a vehicle is described. The method may in particular be designed to increase the comfort of a user of the vehicle (in particular by reducing the required charging time of the electrical energy store of the vehicle). The method comprises determining that the vehicle is driving to a charging station for charging the energy store. Furthermore, the method comprises responding to this by performing one or more consumption-neutral or consumption-reducing measures during the journey of the vehicle in order to reduce the temperature of the energy store in preparation for the charging of the energy store or in order to reduce an increase in the temperature of the energy store in preparation for the charging of the energy store.

According to a further aspect, a road motor vehicle (in particular a passenger car or a truck or a bus or a motorcycle) which comprises the control unit described in this document is described.

According to a further aspect, a software (SW) program is described. The SW program may be designed to be run on a processor (for example on a control unit of a vehicle), and thereby to perform the method described in this document.

According to a further aspect, a storage medium is described. The storage medium may comprise an SW program which is designed to be run on a processor, and thereby to perform the method described in this document.

It should be noted that the methods, devices and systems described in this document can be used both alone and in combination with other methods, devices and systems described in this document. Furthermore, any aspects of the methods, devices and systems described in this document can be combined with one another in various ways. In particular, the features of the claims can be combined with one another in various ways.

The disclosed subject matter is described in more detail below on the basis of exemplary embodiments.

### BRIEF DESCRIPTION OF THE DRAWINGS

FIG. 1 shows components that may be given by way of example of a vehicle.

FIG. 2 shows a flow diagram of a method that may be given by way of example for preparing a vehicle for a charging process.

### DETAILED DESCRIPTION OF THE DRAWINGS

As explained at the beginning, the present document is concerned with increasing the energy efficiency of an at least partially electrically driven vehicle and in particular with increasing the energy efficiency of a (rapid) charging process for charging the energy store of a vehicle.

The electrical energy store of a vehicle should typically not exceed a certain maximum temperature, in particular during a charging process. However, in the course of a charging process, thermal power is produced as a result of the flowing charging current in the energy store of the vehicle and causes the temperature of the energy store to increase. The thermal power depends in this case on the charging power, and typically increases with increasing charging power. During a charging process, the energy store may be cooled actively (by operation of a cooling system of the vehicle) and/or passively (by convection with the ambient air), in order to dissipate at least part of the thermal power.

The cooling power required for cooling the energy store may be reduced by reducing the temperature of the energy store at the beginning of a charging process. In particular, reducing the initial temperature of the energy store at the beginning of a charging process allows the amount of thermal energy that can be taken up by the energy store until the maximum temperature is reached, and consequently does not have to be used up in the form of cooling power to be increased.

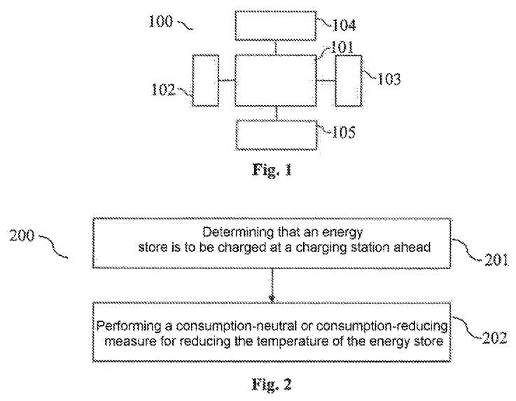

FIG. 1 shows a block diagram with components that may be given by way of example of a vehicle 100. The vehicle 100 comprises a control unit 101, which is designed to determine that the vehicle 100 is being driven to a charging station for charging the electrical energy store 103. This may be ascertained for example on the basis of input data from a user interface 102 of the vehicle 100. Alternatively or in addition, this may be ascertained on the basis of the navigation data of a navigation system (for example on the basis of route planning of the navigation system).

The control unit 101 may also be designed to respond to the determination that the vehicle 100 is on its way to a charging station by initiating one or more measures to lower the temperature of the energy store 103. In particular, one or more measures by which the temperature of the energy store 103 when reaching the charging station is lowered (in comparison with the temperature that the energy store 103 would have when reaching the charging station without carrying out the one or more measures) may be initiated.

One possible measure would in this case be the activation of a cooling system 104 of the energy store 103. However, the operation of a cooling system 104 typically leads to an increased (electrical) energy consumption of the vehicle 100, and consequently to an additional lowering of the state of charge of the energy store 103. As a consequence of this, the amount of electrical energy that can be taken up by the energy store 103 during the charging process is increased, whereby in turn the amount of thermal energy produced is increased. With the preparation operation of a cooling system 104, it is consequently indeed possible for the temperature of an energy store 103 when reaching a charging station to be reduced (in order to provide a greater temperature buffer for the charging process). On the other hand, the reduced state of charge of the energy store 103 when reaching the charging station would have the effect that the amount of electrical energy to be charged is increased, so that the temperature buffer is at least partially diminished again.

The one or more measures therefore preferably comprise one or more measures that are at least neutral, and preferably reducing, with respect to the electrical consumption of the vehicle 100. In particular, in preparation for the charging process during the journey of the vehicle 100, one or more electrical consumers 105 of the vehicle 100 may be deactivated or set to an energy-saving mode, in order to lower the electrical consumption of the vehicle 100 and consequently the loading of the energy store 103 and thus the temperature of the energy store 103 (or to reduce the increase in the temperature of the energy store 103). Alternatively or in addition, one or more (consumption-neutral) measures may be initiated, in order to increase the cooling power for cooling the energy store 103 during the journey of the vehicle 100.

Measures that may be given by way of example are:
Reducing the vehicle speed, whereby the required drive power and the electrical power consumption of the vehicle 100 are reduced. This results in a reduction of the heating up or a cooling down of the energy store 103.
An increased flow can be directed onto the energy store 103 during the journey of the vehicle 100 by fins at the front of the vehicle or by one or more corresponding devices, which improves the cooling of the energy store 103. In this case, the energy store 103 may possibly have cooling ribs, in order to make improved heat exchange possible. Alternatively or in addition, the vehicle speed of the vehicle 100 may be adapted in order to improve the conditions for the flow directed onto the energy store 103 in relation to the heat dissipated.
Switching off or reducing one or more electrical consumers for comfort functions, such as seat heating or an air-conditioning system.

The lowering of the vehicle speed may be performed in such a way that the sum of the travel time to the charging station and the charging time for charging the energy store 103 is improved, in particular minimized. The reduction of the initial temperature of the energy store 103 at the beginning of a charging process typically makes it possible to increase the charging power of the charging process, and consequently to speed up the charging process. Furthermore, lowering the vehicle speed typically leads to reduced energy consumption, and consequently to a higher state of charge of the energy store 103 when reaching the charging station, which likewise has positive effects on the required charging time. Consequently, even with a reduced vehicle speed (and the associated prolongment of the travel time to the charging station), the sum of the travel time and the charging time can be reduced.

The one or more measures for reducing the temperature of the energy store 103 in preparation for a charging process may be combined in a driving mode of the vehicle 100 (for example a charging-preparation driving mode). The control unit 101 may be designed to issue via the user interface 102 of the vehicle 100 an output to a user, in particular a driver, of the vehicle 100 that indicates that the charging-preparation driving mode should be activated in preparation for the charging process. The charging-preparation driving mode may then be activated or not, in dependence on a detected user input.

FIG. 2 shows a flow diagram of a method 200 that may be given by way of example for operating a vehicle 100. The vehicle 100 comprises an electrical energy store 103 for storing electrical energy for an electric drive machine. The method 200 may be performed by a control unit 101 of the vehicle 100. The method 200 comprises the determination 201 that the vehicle 100 is driving to a charging station for charging the energy store 103. This may be ascertained or determined for example on the basis of a planned travel route of the vehicle 100 and/or on the basis of an input by a user of the vehicle 100.

The method 200 also comprises responding to the determination that the vehicle 100 is on its way to a charging station for charging the vehicle 100 by carrying out 202 one or more consumption-neutral or consumption-reducing measures during the journey of the vehicle 100 in order to reduce the temperature of the energy store 103 in preparation for the charging of the energy store 103. In particular, the one or more measures can bring about the effect that the energy store 103 has a reduced initial temperature at the beginning of the charging process at the charging station. Thus, the charging power of the charging process can be increased, and consequently the charging time can be shortened. Furthermore, the restriction to carrying out consumption-neutral or consumption-reducing measures has the effect that the energy store 103 has a relatively increased state of charge at the beginning of the charging process, so that the required charging time for reaching a certain target state of charge (for example of almost 100%) can be shortened further.

The measures described in this document make it possible to prepare the energy store 103 of a vehicle 100 for a (rapid) charging process in an energy-efficient way. Thus, the energy efficiency of a vehicle 100 can be increased. Furthermore, the charging time for a charging operation can thus be reduced.

The present subject matter is not restricted to the exemplary embodiments shown. In particular, it should be noted that the description and the figures are only intended to illustrate the principle of the proposed methods, devices and systems.

1.-11. (canceled)

12. A control unit for a vehicle comprising:
an electrical energy store for storing electrical energy for an electric drive machine, wherein
the control unit is designed to:
determine that the vehicle is driving to a charging station for charging the energy store; and
respond to the determination by initiating one or more consumption-neutral or consumption-reducing measures during the journey of the vehicle in order to reduce the temperature of the energy store in preparation for the charging of the energy store.

13. The control unit according to claim 12, wherein
the one or more measures comprise:
activating an energy-saving mode of an electrical consumer of the vehicle; and
deactivating the electrical consumer.

14. The control unit according to claim 12, wherein
the one or more measures comprise reducing a vehicle speed of the vehicle via the electric drive machine.

15. The control unit according to claim 14, wherein
the control unit is further designed to:
ascertain time information with respect to a reduction of a required charging time for charging the energy store on account of reducing the vehicle speed; and
ascertain the vehicle speed in dependence on the time information so that an overall expenditure of time for the journey to the charging station and for the charging of the energy store is reduced.

16. The control unit according to claim 12, wherein
the control unit is further designed to:
determine the charging power with which the energy store is to be charged; and
only initiate the one or more measures when the charging power is equal to or greater than a power threshold value.

17. The control unit according to claim 12, wherein
the one or more measures are aimed to reduce the temperature of the energy store at the beginning of charging in comparison with a temperature that would occur if the one or more measures were not carried out.

18. The control unit according to claim 12, wherein
the control unit is further designed to:
ascertain navigation data with respect to a planned travel route of the vehicle; or
ascertain input data with respect to an input by a user via a user interface of the vehicle; and
determine, on the basis of the navigation data or the input data, that the vehicle is driving to a charging station for charging the energy store.

19. The control unit according to claim 12, wherein
the control unit is further designed to:
produce an optical or acoustic or haptic output to a user of the vehicle in order to indicate that the one or more measures for reducing the temperature of the energy store should be carried out; and
initiate the one or more measures in dependence on an input by the user.

20. The control unit according to claim 12, wherein
the one or more measures comprise increasing an air stream for cooling the electrical energy store.

21. The control unit according to claim 12, wherein
the control unit is further designed to:
inform the charging station in advance via a wireless communication link that the vehicle is driving to the charging station to charge the energy store; or
reserve the charging station for charging the energy store.

22. A method for operating a vehicle comprising an electrical energy store for storing electrical energy for an electric drive machine, the method comprising:
determining that the vehicle is driving to a charging station for charging the energy store; and
responding to the determination by carrying out one or more consumption-neutral or consumption-reducing measures during the journey of the vehicle in order to reduce the temperature of the energy store in preparation for the charging of the energy store.
